(19) United States
(12) Patent Application Publication
(10) Pub. No.: US 2007/0194717 A1
(43) Pub. Date: Aug. 23, 2007

(54) Lamp for use in a tissue treatment device

(75) Inventor: Andrey V. Belikov, St. Petersburg (RU)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: PALOMAR MEDICAL TECHNOLOGIES, INC., Burlington, MA (US)

(21) Appl. No.: 11/357,401

(22) Filed: Feb. 17, 2006

(51) Int. Cl. H01J 61/35

(52) U.S. Cl. 313/635

(57) ABSTRACT

Electromagnetic radiation (EMR) sources for efficiently transmitting EMR, such as light and near infrared radiation, to tissue to be treated using various cosmetic, dermatological and medical procedures is described. In one aspect, an EMR source includes a coating that has the properties of absorbing relatively little EMR and exhibiting relatively high levels of scattering of EMR. In another aspect, an EMR source is used in a dermatological treatment device that heats tissue at depth. In another aspect, an EMR source is used in a light source assembly that can be incorporated into treatment devices.

### TECHNICAL FIELD

This invention relates generally to methods and apparatus for utilizing energy, e.g., optical radiation, to treat various dermatological and cosmetic conditions. This invention relates specifically to providing a reflective covering to a halogen lamp to improve the efficiency of various devices for treating dermatological and cosmetic conditions.

### BACKGROUND OF THE INVENTION

A halogen lamp is a type of incandescent lamp that has been widely used in the design of dermatological and other devices to provide various treatments for human tissue, especially skin. Halogen lamps generally provide up to 20 percent greater energy efficiency, longer useful life and improved light quality over typical incandescent lamps. Like a typical incandescent lamp, halogen lamps include a tungsten filament. However, the bulb or balloon of a halogen lamp is filled with halogen gas.

The useful life of all incandescent lamps, including halogen lamps, is limited by the state of the filament. The filament is the wire inside the bulb that produces light when heated. The lamp will not work if the filament is broken which may occur as a result of the application of force, such as dropping the lamp, or by lack of tungsten in a particular area over the filament. When any incandescent lamp (one which produces light by heating a tungsten filament) operates, tungsten from the filament is evaporated into the gas of the bulb.

When the tungsten comes in contact with a cool surface it will condense. Often, with incandescent products, the tungsten condenses on the relatively cooler balloon wall. Because the tungsten is deposited on the wall instead of the filament, the filament grows thin over time. Eventually, there will be a point on the filament with so little tungsten that the filament will break and the lamp will stop working. An incandescent lamp “burns out” when enough tungsten has evaporated from the filament so that electricity can no longer be conducted across it.

In a halogen lamp, however, the bulb contains halogen gas. The halogen gas facilitates a “halogen regeneration cycle.” During the halogen regeneration cycle, the halogen gas atoms react with the tungsten vapor so that little or no tungsten condenses on the balloon wall. Instead, the halogen gas carries the tungsten atoms back to the filament where it is deposited. By placing the tungsten back on the filament instead of the wall, it slows the degradation of the tungsten filament, which allows the lamp to last longer. The halogen gas in a halogen lamp carries the evaporated tungsten particles back to the filament and re-deposits them. This gives the lamp a longer life than regular typical incandescent lamps and provides for a cleaner bulb wall for light to shine through.

Halogen lamps produce EMR at various wavelengths and in relatively large amounts. Compared to typical incandescent lamps, halogen lamps produce more electromagnetic radiation (EMR), including visible light and infrared radiation, per unit of energy supplied to the lamp. Infrared, also known as radiant heat, is a form of energy that heats objects directly through a process called conversion. Infrared radiation is emitted by any object that has a temperature (i.e. radiates heat). Infrared light is not visible, but can be felt in the form of heat.

Furthermore, halogen lamps produce more EMR at higher temperatures. Thus, as the lamp gets hotter, it becomes more efficient, producing additional EMR without requiring an increase in power to the lamp. A typical incandescent lamp is inefficient, and lasts only about 750 to 1,000 hours in normal use. The inefficiency is due, in part, to the fact that the lamp generates more infrared heat than light. Halogen lamps, in comparison last longer, and, additionally, burn hotter than normal incandescent lamps. The halogen regeneration cycle occurs at relatively hot temperatures, and halogen lamps, therefore, operate at higher temperatures to maintain that cycle. The halogen regeneration cycle begins when the temperature of the bulb reaches approximately 250° C. The temperature of the bulb of a halogen lamp typical ranges from 250° C. to 600° C. while the temperature of the tungsten filament itself typically ranges from approximately 2500° C. to 3000° C.

Coatings have been used previously in conjunction with halogen lamps for applications such as home lighting, industry lighting and car headlights. For example, dichroic coatings have been used on halogen lamps used as reflector lamps in homes. These coatings are multi-layer interference films that are made of, e.g., dozens of layers of thin materials that selectively reflect or transmit certain wavelengths of visible light, infrared, and ultraviolet EMR. Dichroic coatings have been used since the 1960s to reduce the heat in the beam of certain reflector lamps. Other coatings are designed to reduce the heat in the projected beam (up to 66%), and to absorb ultraviolet light and control the color and amount of light from different sides of a lamp.

Similarly, some halogen lamps contain films, generally applied to the inside surface of the bulb, that reflect infrared heat back into the bulb while allowing visible light to pass through the film. Other coatings are used on halogen lamps in industry to absorb light and reduce glare. In cars, coatings are applied to achieve large collimated beams for illuminating objects at a distance.

### SUMMARY OF THE INVENTION

A halogen lamp having a reflective covering for use in devices designed to treat tissue, such as skin, subcutaneous fat, muscular, bone and other internal organs through skin is disclosed.

One aspect of the invention is a source of electromagnetic radiation for use in a device for treating tissue that includes a halogen lamp that has a highly reflective diffuse reflector covering on the outer envelope of the lamp. The covering includes at least one opening through which electromagnetic radiation that is produced by the lamp can pass. The covering is essentially opaque, and thereby blocks the passage of electromagnetic radiation from within the lamp when it strikes the portion of the envelope that is adjacent to coating.

Preferred embodiments may have one or more of the following features. The covering is made of a liquid glass mixed with highly refractive particles, but can be other materials, such as ceramics, and grains. The covering can be a coating or packed grains in which the lamp is encapsulated. The opening allows electromagnetic radiation to pass through the envelope. The opening can be generally rectangular and can extend for approximately half of the circumference of a cylindrical portion of the lamp. The covering covers the opposite half of the envelope to prevent light from traveling in a direction other than toward the opening. The covering is highly reflective and preferably reflects more than 95 percent of EMR from the lamp, including visible light. The coefficient of absorption of the covering is preferably less than five percent, and is optimally less than 0.5 percent. The thickness of the covering preferably is between 0.5 mm and 5 mm, but other thicknesses are possible.

Another aspect of the invention is a light source assembly for use in a device for treating tissue. The light source assembly includes a lamp having an envelope disposed about a filament. A covering is disposed about a portion of the lamp. The covering forms an opening through which EMR can pass, and it reflects electromagnetic radiation incident on other portions of the envelope. The device includes a treatment window to irradiate tissue with EMR produced by the light source assembly.

Preferred embodiments may have one or more of the following features. The opening formed by the covering can be positioned to allow EMR to pass from the lamp to the treatment window in a straight line.

Another aspect of the invention includes a method of operating a light source when treating tissue with electromagnetic radiation. EMR is produced by the lamp. A portion of the EMR is directed from the lamp to a window that transmits the EMR to the tissue being treated. Another portion of the EMR is prevented from exiting the lamp, and can instead be reflected back into the lamp.

Preferred embodiments may have one or more of the following features. Using this method, some part of the second portion of EMR can be directed from the lamp to the window where it is transmitted to the tissue being treated. The second portion of EMR also elevates the operating temperature of the lamp. A third portion can also be directed from the lamp in a direction other than that of the first portion of EMR, for example, through a second opening formed by a covering.

### BRIEF DESCRIPTION OF THE DRAWINGS

Non-limiting embodiments of the present invention will be described by way of example with reference to the accompanying drawings in which:

FIG. 1 is a side schematic view of a halogen lamp;

FIG. 2 is a bottom schematic view of the halogen lamp of FIG. 1;

FIG. 3 is a side schematic view of a light source assembly that includes the halogen lamp of FIG. 1;

FIG. 4 is a cross-sectional view of an alternate embodiment of a coated lamp.

FIG. 5 is a cross-sectional view of an encapsulated lamp.

FIG. 6 is a cross-sectional view of a dermatological device using an encapsulated lamp.

### DETAILED DESCRIPTION

The characteristics of halogen lamps are particularly beneficial for certain skin treatments, especially where EMR in the near infrared ranges is preferred. One set of such treatments are those that call for heating tissue at depth. Heating tissue at depth can be done with various wavelengths of EMR, both visible and non-visible. Infrared EMR is particularly suited for certain treatments that involve heating tissue at depth.

In devices designed to treat tissue using halogen lamps, including devices using visible light and devices using infrared light, it is beneficial to have as efficient a lamp as possible.

A goal of invention is increasing of efficiency of delivering light from filament which is delivering to treatment tissue and decrease of heating energy which filament lamp exposing to reflectors, electrodes and other components of radiation sources and decrease cost and size of treatment device.

The efficiency of a halogen lamp can be improved in several ways, including by producing a higher level of irradiance without requiring additional power per unit of power supplied by operating at a higher temperature, reflecting a higher percentage of EMR through the lamp to increase the temperature of the filament during operation, using the EMR produced by the lamp more efficiently, and reducing the amount of EMR that is dissipated in a device as heat. Therefore, by improving the efficiency of the halogen lamp, the efficiency of the devices can be improved. Thus, among other things, a device can produce additional EMR irradiation without requiring additional power to the lamp. Similarly, a device can be designed to produce the same level of EMR irradiation by using less powerful components. EMR can be delivered to the tissue more efficiently, the reflectors and other components can be exposed to less EMR, and the cost and size of a device can be reduced.

To improve the efficiency of halogen lamps in devices designed to treat tissue, such as skin, a coating, for example, a ceramic coating that may include sapphire particles, can be used to reflect light from the halogen lamp to the tissue. The coating is more efficient than separate reflectors that are spaced from the lamp that have typically been used in conjunction with such tissue treatment devices. Furthermore, because the coating is applied directly to the bulb of the halogen lamp, essentially all of the EMR is reflected back through the balloon surrounding the tungsten filament. This has the added effect of further heating the halogen lamp without applying additional power from the power source, which results in the halogen lamp producing more EMR per unit of energy used to power the lamp.

To improve the efficiency of halogen lamps in cosmetic, dermatological and medical applications, a reflector spaced from the bulb of the lamp has traditionally been used. Reflectors, however, are often large thereby increasing the size of the device and reflectors result in inefficiencies due to light that is lost when reflected. For example, reflectors coated with a highly reflective substance such as gold, silver or copper, have been employed, because they are capable of reflecting approximately 95 percent of the light or other EMR that is incident on the reflector. Although a relatively high percentage of light is reflected from such reflectors, a substantial amount of light or other electromagnetic radiation is absorbed by the reflector and lost. When the reflector reflects 95 percent of the EMR that is incident upon it, five percent of the EMR is lost every time it is reflected. Thus, light that is reflected multiple times before being transmitted results in approximately 5 percent of the total light being lost each time it strikes the reflector. Furthermore, as the reflective surface of the reflector gets hotter, it becomes relatively less efficient at reflecting light and may need to be cooled to improve reflection and prevent damage to the reflector or other components in proximity to the reflector.

The benefits of being able to raise and/or lower the temperature in a selected region of tissue for various therapeutic and cosmetic purposes have been known for some time. For instance, heated pads or plates or various forms of electromagnetic radiation (EMR), including microwave radiation, electricity, infrared radiation, and ultrasound have previously been used for heating subdermal muscles, ligaments, bones and the like to, for example, increase blood flow, to otherwise promote the healing of various injuries and other damage, and for various therapeutic purposes, such as frostbite or hyperthermia treatment, treatment of poor blood circulation, physical therapy, stimulation of collagen, cellulite treatment, adrenergic stimulation, wound healing, psoriasis treatment, body reshaping, non-invasive wrinkle removal, etc. The heating of tissues has also been utilized as a potential treatment for removing cancers or other undesired growths, infections and the like. Heating may be applied over a small, localized area, over a larger area, for example, to the hands or feet or over larger regions of tissue, including the entire body.

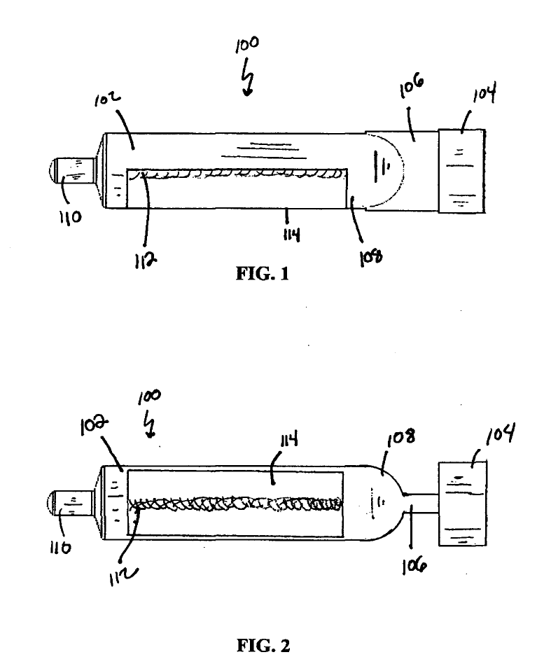

To improve the performance of photocosmetic devices that utilize lamps to provide EMR, a diffuse covering, shown as a ceramic coating in the embodiment of FIG. 1, can be applied to the lamp itself. Such a coating has desirable physical properties for such an application. For example, at the operating temperatures of a halogen lamp, the coating should absorb relatively little light and cause a relatively high amount of scattering of light. In other words, to optimize the efficiency of a coating or other reflective device (collectively referred to as a “covering”) designed to irradiate tissue using EMR from a halogen lamp, the coefficient of absorption should be as low as possible while the coefficient of scattering should be as high as possible.

The covering should also be as close as possible to the outer balloon of the lamp, preferably in contact with the balloon. Consequently, the covering should be able to withstand the hot temperature of the outer balloon of the halogen lamp when the lamp is illuminated, at which time the outer glass balloon of the halogen lamp can be approximately 250-600° C. (The temperature of the outer balloon of the lamp described below is approximately 590° C.) In the preferred embodiment, a ceramic coating including sapphire particles to provide a diffuse reflection is applied directly to the balloon.

For example, in one preferred embodiment, a coating is formed as follows:
1. A first layer of liquid glass (5-10 microns) is formed on the surface of a lamp. (The amount of liquid glass could be varied, however, for example, between 1-1000 microns).
2. A second layer of composite (20-25 microns) is placed on the glass surface. (The amount of composite could be varied, however, for example, between 5-5000 microns.) The liquid glass preferably consists of KOH (18.5 g) (however, mixtures can preferably include 5-30% KOH by weight ), SiO₂ (34.5 g) (however, mixtures can preferably include 15-50% SiO₂ by weight), and H₂O (120 g) (however, mixtures can preferably include 20-80% H₂O by weight). The liquid glass as described has a density of approximately 1.11 to 1.13 g/cm3, although embodiments of coatings having densities outside that range are possible. The dimension of the ZrO₂ particles are 1±0.1 microns (however, particles between 0.5-100 microns can be used. The ZrO₂ particles are obtained from a powder. In its initial powder form, the mass volume of ZrO₂+HfO₂ is greater than 99.3% and the mass volume of HfO₂ is less than 2.2%. (Although other combinations are possible, it is generally preferable to have as high a percentage of ZrO₂ in the initial powder.) The H₂O is preferably pure distilled water.

The composition of the composite is liquid glass (300 mg) (however, mixtures can preferably include 10-50% liquid glass by weight), ZrO₂ (520 mg)(however, mixtures can preferably include 30-90% ZrO₂ by weight), and H₂O (60 mg) (however, mixtures can preferably include 1-20% H₂O by weight).

The coating is applied by cleaning a surface of a lamp, and applying a layer of liquid glass to a thickness of approximately 5-10 microns. The application is dried by air at room temperature for 30-40 minutes. The composite mixture is then drawn to a thickness of approximately 20-25 mcm. The application is dried by air at room temperature for at least 60-70 minutes. The application is heated smoothly without temperature spikes to 78-80° C. during the 60-70 minute drying period. The application is dried at 78-80° C. during an approximately 170-190 minute total drying period. The application is then smoothly cooled to room temperature at the end of the 170-190 minute drying period.

Referring to FIGS. 1 and 2, a halogen lamp 100 with a coating 102 is shown. The halogen lamp 100 includes an electrical connector 104, a neck section 106, a bulb section 108 and a tip section 110. Within lamp 100 is a tungsten filament 112 that extends from the bulb section 108, through neck section 106 and into connector 104, where filament 112 contacts an electrically conductive material to provide an electrical connection to power the lamp 100. Lamp 100 is, for example, a USHIO JCV120V-1000WC3 lamp, which produces 1000W at 120V. However, many other types of lamps could be used. When coated, the life expectancy of the lamp is greater than 70 hours (corresponding to approximately 25,000 pulses at 100 W using pulse widths of 3 seconds and a repetition rate of 0.1 Hz, with air cooling).

The bulb portions of halogen lamps are typically constructed of quartz, rather than glass as in incandescent bulbs, which allows the bulbs to be positioned closer to the filaments to maintain the relatively higher temperatures that halogen lamps require to operate. In lamp 100, the entire exterior bulb 108 of lamp 100 is covered with coating 102, with the exception of an opening 114 that provides a window through which EMR from lamp 100 can exit the lamp. The opening 114 is oriented to allow light to exit the lamp in the direction of the tissue to be treated. In the preferred embodiment, the uncoated opening is 2.8 cm by 1.6 cm, when measured along the surface of the halogen lamp, which is 12.35 mm in diameter. Preferably, if the application calls for concentration of the EMR to achieve a smaller spot size, a higher percentage of the lamp will be coated, approximately 75% or more depending on the configuration.

In the preferred embodiment, the coating of lamp 100 is the layered material described above. The coating 102 has the properties of low EMR absorption and high EMR scattering to provide a diffuse reflection of light. However, other coatings could be used. For example, a coating consisting of a theramic substance could be used to coat a halogen lamp. Alternative embodiments can also include ceramic coatings. Additionally, sapphire particles can be included in any of the described embodiments. The inclusion of varying amounts of sapphire particles can be used to adjust the coefficients of absorption and scattering, but will have a greater impact on the coefficient of scattering, which is dependent on the amount of sapphire particles used. The coefficient of absorption preferably will be less than 5% and which optimally would be less than 0.5 percent.

As the layers of coating are built up, the coated area of the halogen lamp becomes more and more opaque. The effect is similar to viewing light through sheets of paper and adding additional sheets in a stack one at a time. With each sheet, less light is visible through the paper, until ultimately, no light passes through the stack. Similarly, when sufficient material is applied, the final coating is essentially completely opaque and no or very little light or other EMR will be transmitted from the halogen lamp through the coating. When completed, the coating preferably is between 1 mm and 5 mm thick, although other thicknesses are possible.

Alternatively, it may be possible to put the coating on in one application. As another alternative, the coating may be applied as a sheet of material or a film that is adhered to the bulb 108.

Preferably, very little light or other EMR is absorbed by the material that forms the coating. The density and thickness of the coating are optimized to ensure maximum reflection of light from the halogen lamp during operation. For example, as discussed above using a liquid-glass preparation of 1.11 to 1.13 g/cm³ is considered preferable. (However, many other densities are possible.) Therefore, nearly all of the EMR that strikes the coating from the halogen lamp is reflected off of the coating and back towards the tissue to be treated. (As discussed below, the lamp is preferably used in conjunction with optical elements, such as a waveguide, and the coating is oriented to efficiently reflect the EMR toward the optical elements that transmit the light to the tissue being treated.) Additionally, because there is still some small leakage of light through the coating 102, a reflector can be used to further improve the efficiency of transmission of light to the surface of the tissue. (Alternatively, the reflector can be eliminated to save cost and space, depending on the application.) During operation, the reflectivity of the coating is approximately 99.5%, and relatively less light is incident on the reflector than when a halogen lamp is employed without the coating. Thus, less light is lost in the process of reflecting light off of the reflector and towards the waveguide than when no coating is applied to the halogen lamp.

During operation, a system using lamp 100 can deliver significantly more energy to the tissue being treated—approximately 20% or more in some cases—than the same system using a lamp without a ceramic coating. The coating is more efficient than separate reflectors spaced from the bulbs that have typically been used in conjunction with such tissue treatment devices. Furthermore, the coating is applied directly to the bulb of the halogen lamp, which causes the reflected EMR to pass back through the space inside the envelope, which is the outer glass or quartz portion surrounding the tungsten filament of the lamp formed, in this case, by the neck, bulb and tip sections 106, 108 and 110. This has the added effect of further heating the filament 112 without applying additional power from the power source, which results in the halogen lamp producing more EMR per unit of energy used to power the lamp.

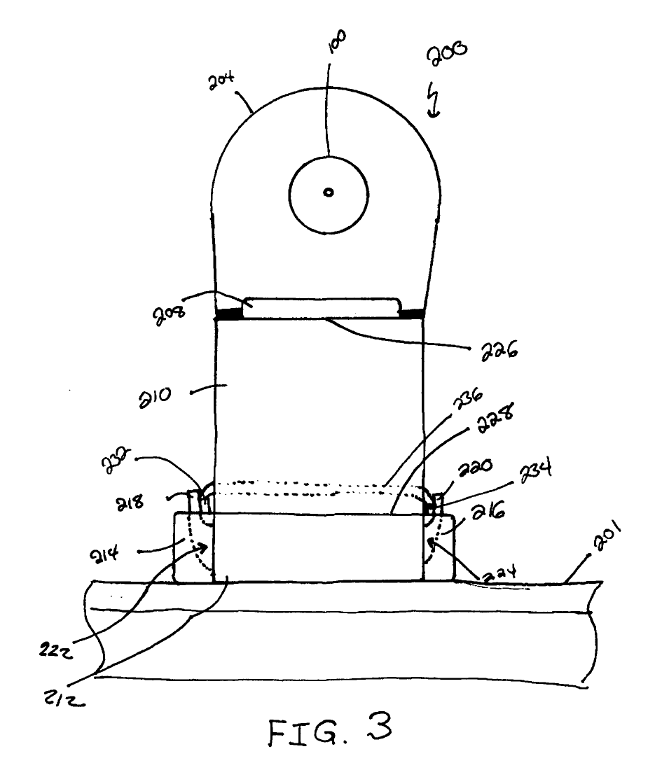

Referring to FIG. 3, a light source assembly 200 for transmitting light to tissue 201 to be treated includes lamp 100, a reflector 204, a sapphire plate 208 (Al₂O₃), a quartz waveguide 210 (SiO₂), a second sapphire plate 212 (Al₂O₃), and a pair of cooling fixtures 214, 216 for circulating water around the second plate 212.

The cooling fixtures each have a coolant input 218 and 234 and a coolant output 220 and 232 respectively. Coolant channels 222 and 224 (depicted by dashed lines in FIG. 3 extend respectively from coolant inputs 218 and 234 to the coolant outputs. The channels are connected around waveguide 210 by a connector tubing 236. The channels 222 and 224 are sealed by an o-ring that (shown as 230 in FIG. 5) that lies between the cooling fixtures 214 and 216 and the plate 212.

During operation, coolant, preferably water chilled to 5° C., flows into the cooling fixture 214 via the coolant input 218, and flows along the edge of plate 212 to cool it. The coolant flows through the channel 222 and out output 232. The fluid then flows through connector tubing 236 and into input 234. The coolant then flows into the cooling fixture 214 via the coolant input 234, and flows along the opposite edge of plate 212 to cool it further. The coolant flows through the channel 224 and out output 220. The fluid then flows back to the chiller, where it is cooled again.

A dielectric coating 226 is provided at the junction between the first plate 208 and the waveguide 210 to match the index of refraction of the two surfaces and, thereby, allow light to pass from the plate 208 to the waveguide 210 more efficiently. The coating 226 is applied to both the underside of aluminum oxide plate 208 and the topside of silicon waveguide 210. Similarly, a dielectric coating 228 is provided between the waveguide 210 and the second plate 212 to match the index of refraction of the two surfaces and, thereby, allow light to pass from the waveguide to the second plate more efficiently.

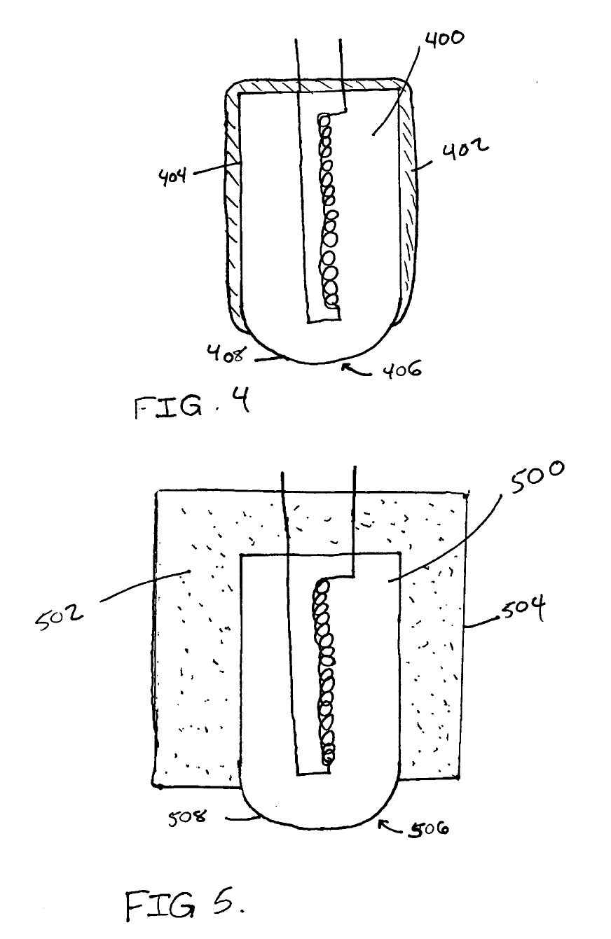

Alternate embodiments of coated lamps are shown in FIGS. 4-5. In FIG. 4, a halogen lamp 400 has a coating 402 around the entire circumference of the bulb 404 of the lamp 400. The coating 402 forms an opening 406 at the tip 408 of the lamp. This configuration, among other things allows for a small spot size.

Referring to FIG. 5, a halogen lamp 500 is shown in a similar configuration as lamp 400. However, the lamp 500 is not coated. Instead it is encapsulated in grains 502 located within cap 504. Grains 502 are a powder-like substance of refractory material with a high heat-conductivity, for example, sapphire, of the size within 0.5-50 microns, located in immediate contact with the surface. In this example, the grains are not adhered to lamp 500. The particles form an opening 506 at the tip 508 of the lamp 500. Alternatively, the grains can also include, for example, ZrO₂, SiO₂, or other appropriate material or combinations of materials having a low coefficient of absorption and a high coefficient of scattering.

The dimension of the space around the lamp 500, in which the grains 502 reside, depends on the application. It is based on the maximum value of the reflection coefficient at the acceptable value of the heat conductivity coefficient. Radiation from the lamp, placed in grains, disperses in the powder-like substance and undergoes numerous refractions and reflections on the bounds of the grains and in them, the thickness of their layer being sufficient, and is emitted efficiently through any opening in the lamp that is not covered with the grains.

This effect can be enhanced by using particles with an appropriate surface contour. Therefore, the size of the grains is preferably small—approximately 500 microns across. There is a lower limit to the size of the grains, however. The size of the grains is based on the wavelength of the EMR to be reflected. The EMR must penetrate the grains, which becomes more difficult with smaller and smaller the grains, because the wavelength of the reflected EMR will begin to exceed the size of the grains at some point.

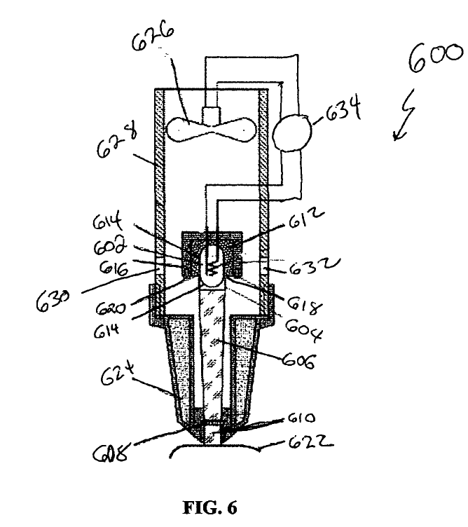

Referring to FIG. 6, a dermatological device 600 includes an encapsulated halogen lamp 602 similar to the encapsulated lamp 500 described in FIG. 5. Device 600 is a handheld dermatological device that includes the lamp 602, a reflector 604, a quartz waveguide 606, a filter 608, and a sapphire window 610. The lamp 602 includes grains 612 that surround the bulb 614 of the lamp 602 and that are contained in a container 616. The container 616 is closed with a lid 618 that is secured to the container by screws 620.

During operation, when the device 600 is pressed against the skin 622, the lamp 602 emits EMR that travels through the space surrounded by reflector 604 and into waveguide 606, either directly or after being reflected by the grains 612 and/or the reflector 604. The EMR then passes through filter 608 and sapphire window 610. The sapphire window 608 is cooled by ice located in a reservoir 624. A fan 626 cools the lamp 602 by forcing air through a housing 628 and out vents 630 and 632. The device 600 is powered by external power supply 634.

Applications in which devices incorporating lamp 100 or other embodiments may be useful include the treatment of various diseases and cosmetic enhancements, particularly, cellulite and subcutaneous fat treatment, physical therapy, muscle and skeletal treatments, including relief of pain and stiffness for muscles and joints, and treatment of spinal cord problems, and treatment of cumulative trauma disorders (CTD's) such as carpel tunnel syndrome (CTS), tendonitis and bursitis, fibromyalgia, lymphedema and cancer therapy and skin rejuvenation treatments, including, for example, skin smoothing, wrinkle and rhytide reduction, pore size reduction, skin lifting, improved tone and texture, stimulation of collagen production, shrinkage of collagen, reduction of skin dyschromia (i.e. pigment non-uniformities), reduction telangiectasia (i.e. vascular malformations), improvement in skin tensile properties (e.g. increase in elasticity, lifting, tightening), treatment of acne, hypertrophic scars, reducing body odor, removing warts and calluses, treating psoriasis, and decreasing body hair.

Halogen lamps produce EMR over a broad range of wavelengths, from approximately 300 nm to above 2500 nm, with EMR being produced at a peak efficiency of approximately 900 nm to 1250 nm depending on the temperature of the filament of the lamp. For example, some halogen lamps produce EMR most efficiently at approximately 900 nm when the filament temperature is approximately 3100° K, and produce EMR most efficiently at approximately 1250 nm when the filament is approximately 2100° K. (The preceding values are exemplary only, as the values will change depending on various parameters such as lamp specifications, environmental conditions and the characteristics of the power source.)

Therefore, halogen lamps can be used for treatments in which the desired EMR output is within the range that the lamp will produce, i.e., approximately 300 to 2500 nm. By way of example, UV, violet, blue, green, yellow light or infrared radiation (e.g., about 290-600 nm, 1400-3000 nm) can be used for treatment of superficial targets, such as vascular and pigment lesions, fine wrinkles, skin texture and pores. Blue, green, yellow, red and near IR light in a range of about 450 to about 1300 nm can be used for treatment of a target at depths up to about 1 millimeter below the skin. Infrared light in a range of about 800 to about 1400 nm, about 1500 to about 1800 nm or in a range of about 2050 nm to about 2350 nm can be used for treatment of deeper targets (e.g., up to about 3 millimeters beneath the skin surface). The following table shows examples of the wavelengths of electromagnetic energy that are thought to be suitable for treating various cosmetic and medical conditions.

TABLE 1
Uses of Light of Various Wavelengths In Photocosmetic Procedures

| Treatment condition or application | Wavelength of Light, nm |
|---|---|
| Anti-aging | 400-3000 |
| Superficial vascular | 290-600 |
| | 1300-3000 |
| Deep vascular | 500-1300 |
| Pigmented lesion, de pigmentation | 290-1300 |
| Skin texture, stretch mark, scar, porous | 290-3000 |
| Deep wrinkle, elasticity | 500-1350 |
| Skin lifting | 600-1350 |
| Acne | 290-700, 900-1850 |
| Psoriasis | 290-600 |
| Hair growth control | 400-1350 |
| PFB | 300-400, 450-1200 |
| Cellulite | 600-1350 |
| Skin cleaning | 290-700 |
| Odor | 290-1350 |
| Oiliness | 290-700, 900-1850 |
| Lotion delivery into the skin | 1200-3000 |
| Color lotion delivery into the skin | Spectrum of absorption of color |
| | center and 1200-3000 |
| Lotion with PDT effect on skin | Spectrum of absorption of |
| condition including anti cancer effect | photo sensitizer |
| ALA lotion with PDT effect on skin | 290-700 |
| condition including anti cancer effect | |
| Pain relief | 400-3000 |
| Muscular, joint treatment | 600-1350 |
| Blood, lymph, immune system | 290-1350 |
| Direct singlet oxygen generation | 1260-1280 |

While several embodiments of the invention have been described and illustrated herein, those of ordinary skill in the art will readily envision a variety of other means and structures for performing the functions and/or obtaining the results and/or advantages described herein, and each of such variations or modifications is deemed to be within the scope of the present invention.

For example, those skilled in the art will appreciate that while embodiments have been described in the context of handpieces that can be used interchangeably with a base unit, many other embodiments are possible. For example, the coating could be applied to a structure disposed about a halogen lamp rather than to the halogen lamp itself. Such a structure could be placed in close proximity to the lamp to reflect EMR back through the bulb surrounding the filament of the lamp. The coating could be configured to provide openings or passages other than a window through which EMR could pass. For example, a ring extending about all or part of the circumference of the halogen lamp could be provided. Similarly, multiple windows or rings or other openings could be provided. Openings having irregular shapes could also be provided. The coating could be configured to allow light to pass in multiple directions at once.

Additionally, the lamp could be used in devices other than handpieces. For example, where applications require longer treatment pulses or longer treatment times to achieve deep heating of tissue, devices that are not required to be held during operation would be advantageous. Thus, a device intended to treat one area of tissue for an extended period could be configured in the form of a pressure cuff or a stationary heating pad that could be laid, taped, clipped, strapped, etc. to the person being treated.

More generally, those skilled in the art would readily appreciate that all parameters, dimensions, materials, and configurations described herein are meant to be exemplary and that actual parameters, dimensions, materials, and configurations will depend upon specific applications for which the teachings of the present invention are used. Those skilled in the art will recognize, or be able to ascertain using no more than routine experimentation, many equivalents to the specific embodiments of the invention described herein. The present invention is directed to each individual feature, system, material and/or method described herein. In addition, any combination of two or more such features, systems, materials and/or methods, if such features, systems, materials and/or methods are not mutually inconsistent, is included within the scope of the present invention.

1. A source of electromagnetic radiation for use in a device for treating tissue, comprising:
a halogen lamp including an envelope, an electrical connector, and a filament;
a reflective covering disposed about said envelope, said covering being substantially opaque and configured to provide at least one opening through which electromagnetic radiation produced by the lamp and reflected by the covering can pass for application to the tissue to be treated.

2. The source of claim 1 wherein said opening is generally rectangular.

3. The source of claim 1 wherein said lamp has a substantially cylindrical portion and said opening extends for approximately half of the circumference of the cylindrical portion.

4. The source of claim 1 wherein said opening is generally circular.

5. The source of claim 1 wherein said lamp has a substantially cylindrical portion and said opening is disposed at an end of the cylindrical portion.

6. The source of claim 1 wherein said covering covers substantially at least half of said envelope.

7. The source of claim 1 wherein said covering covers substantially at least 75 percent of said envelope.

8. The source of claim 1 wherein said covering is a coating.

9. The source of claim 8 wherein said covering is a diffuse reflective coating

10. The source of claim 9 wherein said covering is made from one of the following materials: ceramic and liquid glass.

11. The source of claim 1 wherein said covering includes grains encapsulated about said lamp.

12. The source of claim 10 where said grains include at least one of the following materials: Al₂O₃, ZrO₂, SiO₂, ceramic powder, diamond, and titanium oxide.

13. The source of claim 10 wherein the diameter of said grains is less than or equal to approximately 500 microns.

14. The source of claim 1 wherein said covering reflects more than 99 percent of electromagnetic radiation incident on a surface of said covering.

15. The source of claim 1 wherein said covering reflects more than 99 percent of the visible and infrared light that is incident on a surface of said covering.

16. The source of claim 1 wherein said covering has a coefficient of absorption less than five percent.

17. The source of claim 1 wherein said covering has a coefficient of absorption less than 1 percent.

18. The source of claim 1 wherein said covering has an average thickness that is greater than or equal to approximately 0.5 mm.

19. The source of claim 1 wherein said covering has an average thickness that is less than or equal to approximately 5 mm.

20. The source of claim 1 wherein said covering has a high coefficient of scattering.

21. A light source assembly for use in a device for treating tissue, comprising:
a lamp having an envelope disposed about a filament;
a reflective covering disposed about said lamp, said covering configured to form at least one opening through which electromagnetic radiation that is produced by the lamp and reflected from the covering can pass; and
a first window configured to irradiate tissue with electromagnetic radiation from the at least one opening during operation of the light source assembly.

22. The light source assembly of claim 21 wherein said at least one opening is positioned to allow light to pass from said opening to said window in a straight line.

23. A method for treating tissue, comprising the steps of:
producing electromagnetic radiation from a lamp having a reflective covering and at least one opening in said reflective covering; and
directing light from the at least one opening to the tissue to be treated.
